(19) United States
(12) Patent Application Publication
(10) Pub. No.: US 2007/0018549 A1
(43) Pub. Date: Jan. 25, 2007

(54) Highstrength discharge lamp with low glare and high efficiency for vehicles

(76) Inventors: Guosheng Chai, Nanhai, Fushan (CN); Zhengming Yang, Nanhai, Fushan (CN); Guangyi Gao, Nanhai, Fushan (CN); Ming Zhang, Nanhai, Fushan (CN)

Correspondence Address: CHARLES E. BAXLEY, ESQ., 90 JOHN STREET, THIRD FLOOR, NEW YORK, NY, 10038, US

(21) Appl. No.: 10/560,562

(22) PCT Filed: Apr. 29, 2004
(86) PCT No.: PCT/CN04/00429

§ 371 Date: Dec. 12, 2005

(51) Int. Cl. H01J 61/20

(52) U.S. Cl. 313/17; 313/639

(57) ABSTRACT

The invention provides a high intensity discharge lamp with a lamp cap, which has a simple and firm structure, higher thermal stability, lower glare and higher efficiency. The discharge lamp comprises an arc tube, which is filled with substances for gas discharge. The arc tube comprises a bulbous or ellipsoidal portion. Surrounding the arc tube is a tubular envelope; the envelope has an enlarged portion, which is similar to the bulbous or ellipsoidal portion disposed of the bulbous portion of the arc tube. The distance between the envelope and the outer wall of the arc tube is uniform; it makes the temperature distribution on the wall of arc tube more uniform, then the thermal stability, the luminous and electricity parameters of the lamp are improved. More important is that the invention can reduce the light refraction and reflection which occurred between the inner surface of the envelope and the outer surface of the arc tube and also between the two interface of envelope wall and space, thereby more light directly emitts out from the enlarged ball shaped portion of invention and the invention reduce the occurrence of glare.

### BACKGROUND OF THE INVENTION

The normal low power xenon metal halide discharge lamps such as the capped lamp known from US patent US005736811A, US005646471A have been used as head light of vehicles in Japan and Europe widely. But these kind of lamps installed in vehicle lanterns always emits much more glare comparing with halogen tungsten lamps. Therefore engineers must design special lamp lantern, reflectors, lens and lens hood even light shield to limit glare and form the beam profile meeting with the requirements of vehicle lamp regulation. This is very hard work with much higher cost.

The invention transform the glare into beam light and increase the efficiency of it.

The normal capped vehicle xenon metal halide lamps need a very complex and expensive accessory to fix the raw lamp at the right position on cap stably. The invention gives a much simple way to fix the raw lamp on cap with much lower cost.

### DESCRIPTION OF THE INVENTION

The capped xenon metal halide discharge lamp for vehicles includes an arc tube (1) with two neck shaped portions (2a, 2b). These two neck shaped portions are gastight sealed for two electrode connectors (4a, 4b). The arc tube and two neck shaped portions are wrapped by an outer gastight tubular envelope (5) but with a ball shaped portion (5a), which just surround the ball shaped arc tube (1) The first end of envelope is fixed on a cap (15). A nickel wire (7) is through bridge (8) or directly connected to current conduct (4b) of the second electrode (3b). Wire (7) runs along out side of lamp to connect the second current supply conductor (14). The end of second neck shape portion of arc tube (2c) is expanded to bell shaped, the edge of the bell (2c) nearly touches with the outer envelope (5) and then gastight seal both by flame. There is a cylinder shaped sink (16) at the surface center of cap (15) and three or more (such as four) stainless steal poles (11) are implanted on the cap surface surrounded the sink (16). The first end of lamp is inserted in the sink (16), there is a ring shaped hoop (10) constructed by one or two or four sections, which is tightly bind round the lower part of outer envelope (5). Four poles (11) are inserted in four holes (10a 10b) on the wings of ring shaped hoop (10) respectively and melt together by point welding.

It is the object of this invention to provide a capped xenon metal halide lamp for vehicles with higher light beam efficiency, less glare, more uniform wall temperature distribution of are tube, more stable luminous and electricity parameters and less cost.

According to the invention this object is achieved in such a way. The outer envelope (5) of arc tube (1) is not real straight tubular shaped but with a ball shaped portion (5a) just surround the ball shaped arc tube (1). But the arc tube of normal xenon metal halide lamp for vehicle is surrounded by straight tubular envelope. This invention is very helpful to reduce the glare from arc tube and increase the lighting efficiency, it is very clear from following description.

The theory of geometric optics shows that when the light beam is projected to a glass plate with accidence angle i (FIG. 2), a part of the beam light will be reflected at the interface I between air and glass plate with reflection angle i which is the same as accidence angle, another part of beam light going into glass plate will be refracted by glass with an angle i′.
n₁ sin i=n₂ sin i′
Where n₁ and n₂ are the refraction index of air and glass respectively.

The refracted light beam will be divided to two parts at the interface II of glass and air, the first part will go out through glass plate and become transmission light, another part of refracted beam will be reflected again by second interface II, then go back to first interface I, then a part of this reflected light go out and become transmission light, another part of it will be reflected again by first interface I. Obviously a part of reflect light will continue to reflect between two interface I and II time after times, every time a part of reflected beam light go out through interface and become transmission light.

From the simple geometric optic theory of reflects, refract and transmission, we understand that very well, for the xenon metal halide lamp with tubular outer envelop, the light emitted from arc tube will be reflected partially by inside surface I of outer envelope (FIG. 4) another part of the light through interface I enter envelope glass and will refracted by envelope glass material, then partially transmits and partially reflect while the light beam arrive the outer interface II of envelope and air. This process will continue in the space between interface I and II, and in the space between the arc tube and envelope and also between the outer surface and inside surface of arc tube. Therefore the light emitted from arc is separated, a part of it direct emits out as transmission beam, another part diverges toward two ends and decay along lamp axis. (sea FIG. 4) because of reflections and refractions.

All divergence light is the source of glare. This is the reason why drivers always think that the serious glare is a partner of xenon metal halide lamp. But this invention can improve it in large-scale.

The main points of this invention are:
1. The outer envelope of arc tube is designed as tubular shaped but with a ball shaped section in the middle of envelope just surround the ball shaped arc tube. The wall of ball shaped envelope is parallel with the wall of arc tube. Therefore the light from arc tube will directly emit out through the arc tube and ball shaped envelope with a very small reflection because the direction of radiation is almost perpendicular to both of two walls (FIG. 3) Obviously, compared with straight tubular shaped envelope the beam efficiency of invention lamp increases but the glares reduce. Further more the ball shaped envelope courses more uniform temperature distribution on arc tube, therefore all parameters of this lamp get better such as higher luminous efficiency, better rendering index, higher reliability and longer lifetime.
2. The sealing type of the end far from cap of invention is different with normal lamp. The far end of envelope of normal lamp is heated by flame to the temperature that the quartz is melted and shrank together with the neck portion of arc tube then obtain gastight sealing. To invention lamp it does not shrink the far end of envelope but enlarge the far end of arc tube neck to get bell shaped mouth before sealing, the diameter of bell mouth edge is near but smaller than the inter diameter of outer envelope, then move both edges together and heat them by special burner until melted together for gastight sealing.

This kind of sealing way is simpler, less glare emission from the end which just like a window for light emission and it also shortens the length of lamp, the last point is good for anti vibration.
3. The third main point of this invention is the way for fixing raw lamp on cap. In this invention few (three or more) stainless steel poles are implanted in the cap surface around the lamp which is mounted at the center sink (16) on the cap surface and there is a metal ring shape hoop (10) constructed by one or two or four sections as shown in FIG. 7 FIG. 8 and FIG. 9 which bind around the lower part of lamp. The four poles on cap are just inserted in four wing holes of the hoop respectively and melted together by point welding. This way is simpler, cheap and firm.

### BRIEF DESCRIPTION OF THE DRAWINGS

Embodiments of invention xenon metal halide lamp for vehicles are shown in the drawing, in which

FIG. 1 shows the total embodiment of the invention in side elevation, partly broken away;

FIG. 2 reflection light refraction light and transmission light of glass plate;

FIG. 3 shows the beam light trace from ball shaped envelope of invention lamp;

FIG. 4 shows the beam light trace from tubular envelope of normal lamp;

FIG. 5 shows a variation of FIG. 1 in side elevation;

FIG. 6 shows the drawing of the cap with a ring shaped hoop that for fixing the lamp;

FIG. 7 shows the ring shaped hoop with four wing holes formed by one metal ribbon;

FIG. 8 shows the half of ring shaped hoop;

FIG. 9 shows the ring shaped hoop constructed by four sections;

FIG. 10 shows the cap of lamp with four implanted poles.

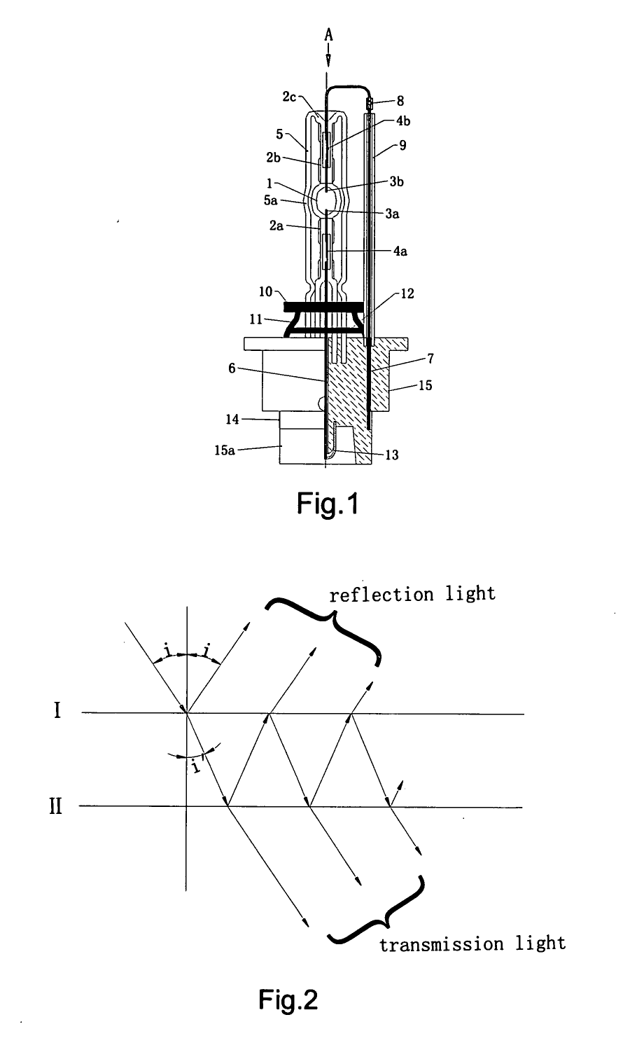

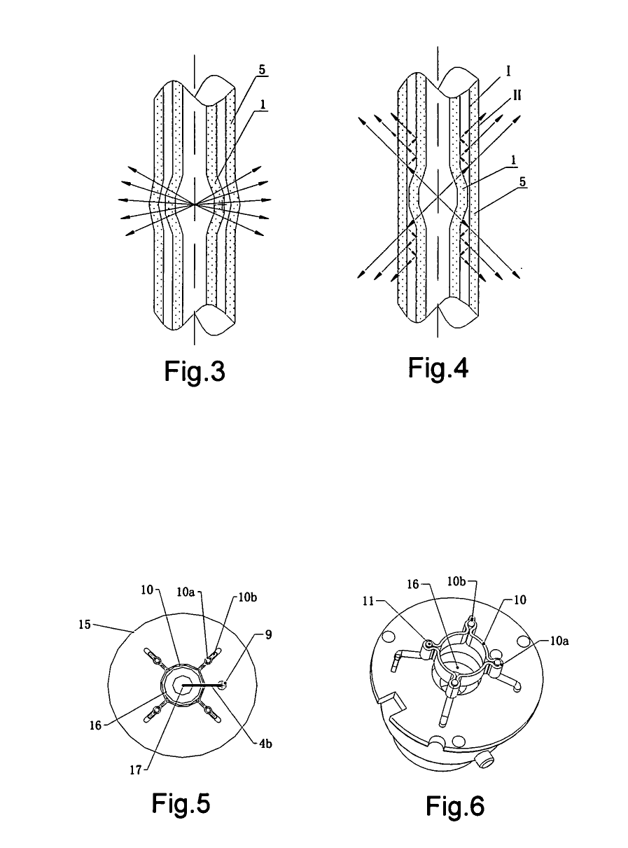

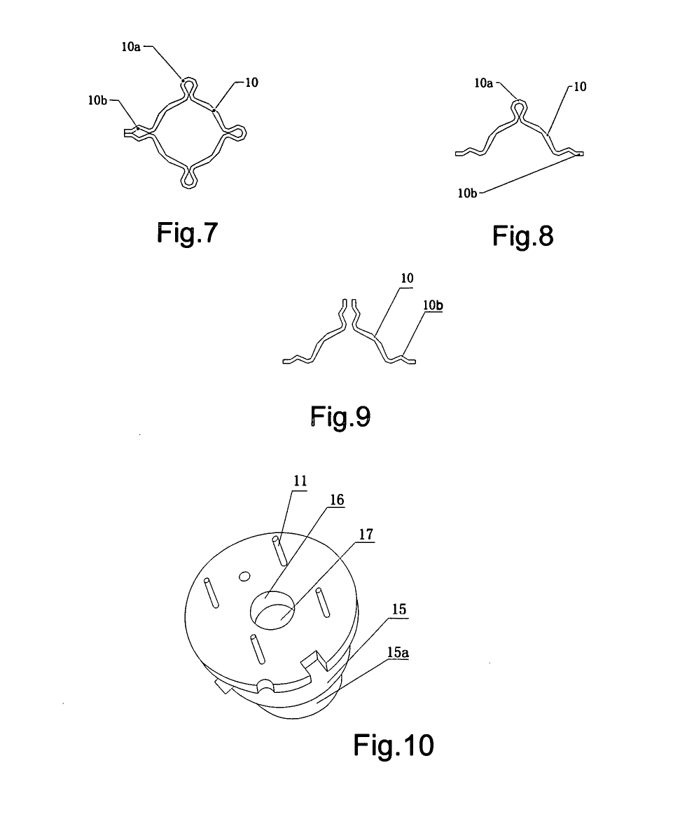

We claim:

1. A capped xenon metal halide discharge lamp for vehicles is constructed of an arc tube and a gastight outer envelope, the arc tube is made of pure quartz glass and filled with high pressure xenon of 6 atmosphere suit amount of Hg and metal halide pellet, the outer envelope is made of the UV stop quartz glass. In the space between arc tube and envelope the air is exhausted to high vacuum. Characterized in that the section of outer envelope surround arc tube is formed to ball shaped and two walls both of arc tube and ball shaped envelope is nearly parallel.

2. A capped xenon metal halide discharge lamp for vehicles as claimed in claim 1 characterized in that the ball shaped section of envelope can be changed to other shaped section such as ellipse shaped or cylinder shaped but the diameter is a little bigger than other section of this envelope.

3. A capped xenon metal halide discharge lamp for vehicles as claimed in claim 1 and claim 2, characterized in that the end 2c of neck portion of arc tube is enlarged to bell shaped and the diameter of bell edge is a little smaller than the inter diameter of envelope, move the envelope till the edges both of bell and envelope meeting together then heat and melt them by flame for gastight sealing.

4. A capped xenon metal halide discharge lamp for vehicles as claimed in claim 1 claim 2 and claim 3 characterized in that the lamp is firmly fixed on cap in this way: a part near cap surface of outer envelope is firmly bind by a ring shaped hoop with few (three or more such as 4) wing holes. There are few (same number as wing holes) poles implanted on the surface of cap, these poles are just matched with wing holes, insert poles into holes and point welding make the holes and poles melt together.

5. A capped xenon metal halide discharge lamp for vehicles as claimed in claim 1 claim 2 claim 3 and claim 4, characterized in that the ring shaped hoop that fix the lamp on cap can be constructed by one or two or four pieces of metal (such as stainless steel) ribbons.
